(19) United States
(12) Patent Application Publication
(10) Pub. No.: US 2024/0196876 A1
(43) Pub. Date: Jun. 20, 2024

(54) LURE

(71) Applicant: Taizo SHIMAZAKI, Nogoya (JP)

(72) Inventor: Taizo SHIMAZAKI, Nogoya (JP)

(21) Appl. No.: 18/554,878

(22) PCT Filed: May 17, 2022
(86) PCT No.: PCT/JP2022/020453

§ 371 Date: Oct. 11, 2023

(30) Foreign Application Priority Data
May 19, 2021 (JP) 2021-084310

(51) Int. Cl. A01K 85/00

(52) U.S. Cl. CPC A01K 85/1863; A01K 85/1837

(57) ABSTRACT

A lure that can further effectively appeal to fish underwater (especially fish lurking in deep waters) by sending feeding sounds and bubbles downwards more reliably is disclosed. The lure comprises a body having a shape resembling a small fish; and a cup that is attached to the body 3, and that has the recessed space for containing air when the body enters water. With this configuration, the lure can effectively appeal to fish underwater (especially fish lurking in deep waters) by sending feeding sounds and bubbles downwards more reliably.

### CROSS-REFERENCE TO RELATED APPLICATIONS

This application is a national phase application under 35 U.S.C. § 371 of International Application No. PCT/JP2022/020453 filed May 17, 2022 entitled “LURE,” which claims the benefit of and priority to Japanese Patent Application No. 2021-084310 filed May 19, 2021, the contents of both of which being incorporated by reference in their entireties herein.

### TECHNICAL FIELD

The present disclosure relates to a lure for fishing.

### BACKGROUND

Conventionally, in terms of fishing, it has been known that the catching sound of a small fish as bait leads to a successful catch. Therefore, various lures that can generate a catching sound have been used. For example, a lure called a popper has a cup-shaped head so that it floats horizontally against the water surface or the butt of the lure is submerged below the water surface. In a case when the lure is pulled on the surface of the water when fishing, it can generate a feeding sound and bubbles from the cup on the head. As a result, it can enhance the fish-attracting effect.

### BRIEF SUMMARY

However, in terms of the conventional lure called a popper mentioned above, when the fishing line is strongly pulled, the lure moves horizontally and slightly submerges in the water. This causes air to be contained in the cup on the head of the lure to create a feeding sound. In this case, as shown in FIG. 6(a), the opening surface of the cup 11 of the lure 10 is at an angle nearly perpendicular to the water surface. As a result, air can only be contained in the portion of the cup 11 that is floating above the water surface, and the appeal to fish is not sufficiently efficient.

Furthermore, as shown in FIG. 6(b), the lure 10 is structured so as to make a feeding sound when the lure 10 is pulled slightly below the water surface from the horizontal direction of the water surface. As a result of this, the propagation of the feeding sound underwater and the formation of bubbles are mostly horizontal along the water surface, which poses a problem in that, for example, the lure lacks appeal to fish lurking below.

The present disclosure has been made in view of the above-mentioned problems and discloses a lure that can further effectively appeal to fish underwater (especially fish lurking in deep waters) by sending feeding sounds and bubbles downwards more reliably.

According to various embodiments of the present disclosure, a lure is described comprising: a body having a shape resembling a small fish: and a cup that is attached to the body, wherein the cup has a recessed space for containing air when the body enters water.

As for this lure, the cup has a bowl shape, and the cup is provided such that the head of the body is located at the front, the cup is attached to the tail of the body so as to make the opening face of the bowl-shaped cup direct forward.

As for this lure, it is optional that the lure further comprises a cup connection member that connects the tail end of the body with the bottom of the cup, wherein a ratio between the height of the body and the diameter of the opening surface of the cup is in the range of 5:1 to 0.5:1.

As for this lure, wherein a specific weight distribution of the body is determined so as to make the head of the lure submerged into the water and make the tail completely float above the water surface during a floating posture with no action, and wherein the lure dives into the water while maintaining an acute angle posture against the water surface during an action.

As for this lure, wherein the cup further comprises a through hole formed on the bottom side of the cup, and wherein the through hole can be penetrated through the body of the lure.

The lure according to this disclosure comprises a body having a shape resembling a small fish: and a cup that is attached to the body, and that has the recessed space for containing air when the body enters water. For example, this cup has a bowl shape. Provided that the head of the body is located at the front, the cup is attached to the tail of the body so as to make the opening face of the bowl-shaped cup direct forwardly. With this configuration, the lure according to this disclosure can further effectively appeal to fish underwater (especially fish lurking in deep waters) by sending feeding sounds and bubbles downwards more reliably.

### BRIEF DESCRIPTION OF THE DRAWINGS

FIG. 1(a) is a perspective diagram showing a lure according to an embodiment of this disclosure.

FIG. 1(b) is a side view diagram showing the lure of this disclosure.

FIG. 1 (c) is a top view diagram showing the lure of this disclosure.

FIGS. 2(a) and 2(b) are diagrams to explain the underwater movement of the lure.

FIG. 3 is an explanatory diagram showing a lure according to a first variation of the embodiment of this disclosure.

FIGS. 4(a), 4(b) and 4(c) are explanatory diagrams showing a cup using a lure according to a second variation of the embodiment of this disclosure.

FIG. 5 is a perspective diagram showing the lure according to the variation of the embodiment of this disclosure.

FIGS. 6(a) and 6(b) are reference diagrams to explain the underwater movement of a conventional lure called a popper.

### DETAILED DESCRIPTION

A lure according to an embodiment of the present disclosure will be explained by referring to the drawings. A lure is an artificial bait used for fishing, and the lure according to this embodiment belongs to a type called a popper that moves on the surface layer of the water surface. This lure, called a popper, is characterized by the fact that it can appeal to fish by generating feeding sounds and bubbles near the water surface while operating the rod or lure.

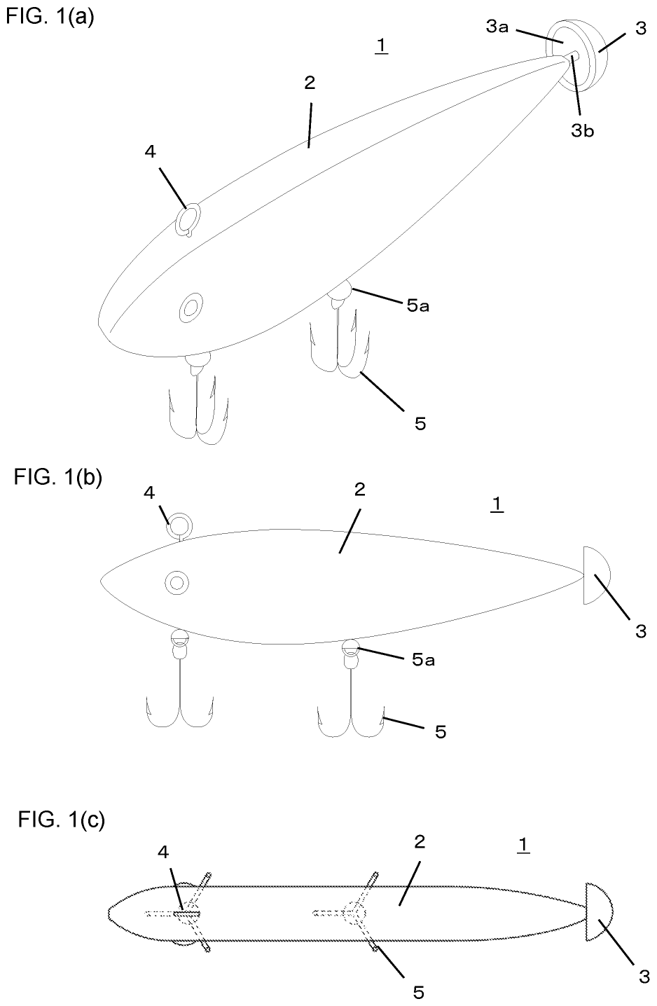

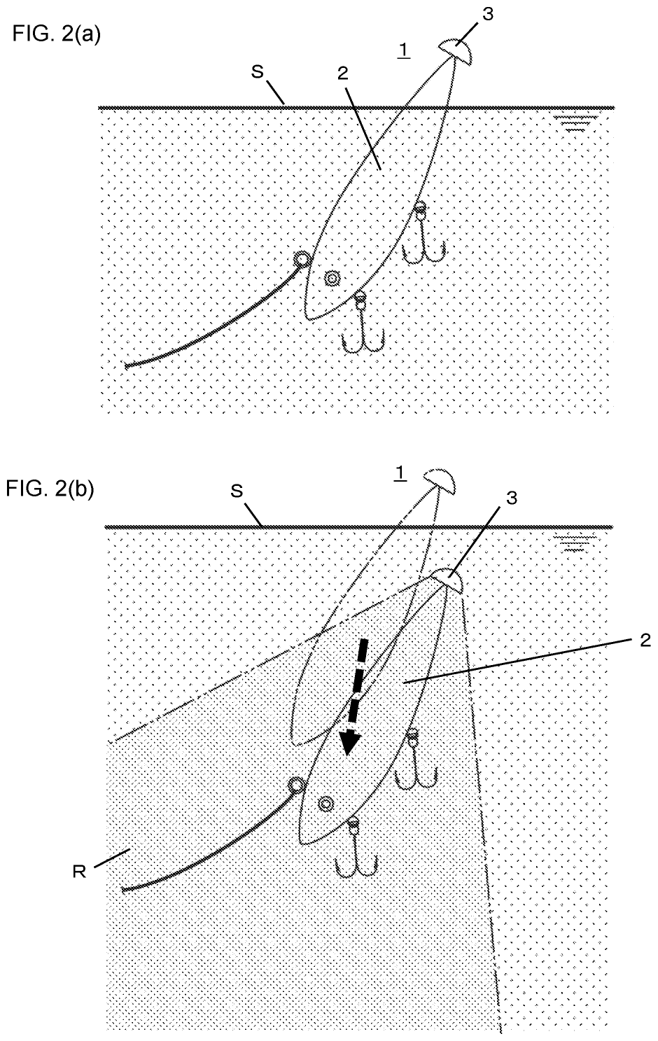

First, the configurations of the lure according to this embodiment will be explained by referring to FIGS. 1 and 2. The lure 1 comprises a body 2, a cup 3, a fishing line connection part 4, and a hook 5, as shown in FIG. 1(a).

The body 2 has a small fish like shape and is made of lightweight materials such as wood and synthetic resin (ABS resin, etc.), and has a hollow structure so that the lure 1 can float on the water surface. It is noted that there are a variety of total lengths, heights (vertical length at the widest position), and thicknesses of the body 2.

The cup 3 is attached to the body 2 and has a recessed space 3a for containing air when the body 2 enters water. The cup 3 of this embodiment has a bowl shape as shown in FIG. 1. Provided that the head of the body 2 is located at the front, the cup 3 is attached to the tail of the body 2 so as to make the opening of the bowl-shaped cup 3 direct forward. For example, as shown in FIG. 1 (a), the tail end of the body 2 and the bottom of the cup 3 may be connected and fixed via a cup connection member 3b. It is noted that the cup 3 may be removably fixed to the body 2 using a screw-in structure or the like. The material of the cup 3 is, for example, brass, reinforced synthetic resin such as ABS, or silicone.

The ratio between the height of the body 2 and the diameter of the opening surface of the cup 3 is optionally in the range of 5:1 to 0.5:1. With this ratio, in a case when the cup 3 gets into water, sufficient air can be contained in the bowl-shaped recessed space 3a to generate feeding sounds and bubbles.

The fishing line connection part 4 is, for example, an annular ring formed on the head side of the body 2. The fishing line is connected to the fishing line connection part 4. The other end of this fishing line is connected to a fishing rod. The hook connection part 5a is arranged, for example, on the abdomen of the body 2 (in this embodiment, it is formed at two places). The hook 5 as a fishing hook is connected thereto.

Next, the underwater movement of the lure 1 according to this embodiment during lure fishing will be described by referring to FIG. 2.

First, the lure 1 is thrown into the target point with a fishing rod. Once the lure 1 reaches the water surface S, the floating angle of the body 2 is determined according to the specific weight distribution of the body 2. Herein, as shown in FIG. 2(a), for example, the specific weight distribution of the lure 1 is determined so as to make the head of the lure 1 submerged into the water and make the tail completely float above the water surface S (i.e., a handstand posture) during a floating posture with no action. This specific weight distribution is achieved by, for example, using a material with a high specific weight on the head side of the body 2. In this state, while most of the body 2 is underwater, the cup 3 is above the water surface S.

Next, as shown in FIG. 2(b), during an action when the fishing line is strongly pulled, the lure 1 dives into the water while maintaining an acute angle posture against the water surface S. In this state, the lure 1 enters the water forcefully while containing a relatively large amount of air in the recessed space 3a of the cup 3, which is equipped with the tail part of the lure 1. Since this recessed space 3a can contain a lot of air when the cup 3 enters the water, it is possible to produce louder feeding sounds and larger bubbles. In addition, as the lure 1 dives at an acute angle against the water surface, the generated feeding sound is concentrated within the range R surrounded by the chain line in FIG. 2(b). As a result, the sound is transmitted downward in the water (towards the depths), appealing to fish lurking in deeper places. This is because larger fishes are generally more wary and often lurk in deeper places.

As described above, the lure 1 according to the present embodiment comprises the body 2 having a shape resembling a small fish (a shape close to an ellipse when viewed from the side), and the cup 3 that is attached to the body 2 and has the recessed space 3a for containing air when the body 2 gets into the water. This cup 3 has a bowl shape. Provided that the head of the body 2 is located at the front, the cup 3 is attached to the tail of the body 2 so as to make the opening of the bowl-shaped cup 3 direct forwardly. With this configuration, the lure 1 is operable to effectively appeal to fishes underwater (especially fishes lurking in deep waters) by sending feeding sounds and bubbles downward more reliably. In other words, conventional hoppers are not enough to appeal downward, because those hoppers deliver sounds and bubbles horizontally. However, the lure 1 according to this disclosure can deliver the sounds and bubbles downward very effectively. Due to this effect, it is possible for this lure 1 to appeal to fishes lurking in deeper places.

### Variation 1

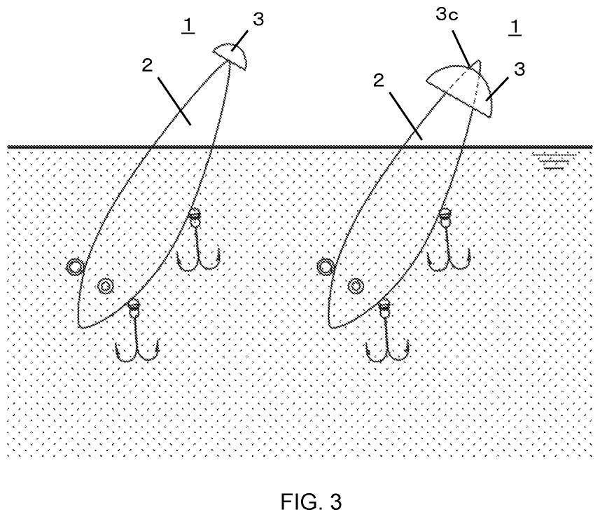

A first variation of this embodiment will be explained by referring to FIG. 3. In terms of the lure 1 according to this variation 1, the cup 3 has a through hole 3c formed on the bottom side. Because the through hole 3c can be penetrated through the body 2, the cup 3 is placed not on the tail side of the body 2 but is placed near the abdomen side. With this configuration, the same effects as in the above embodiment can be achieved.

### Variation 2

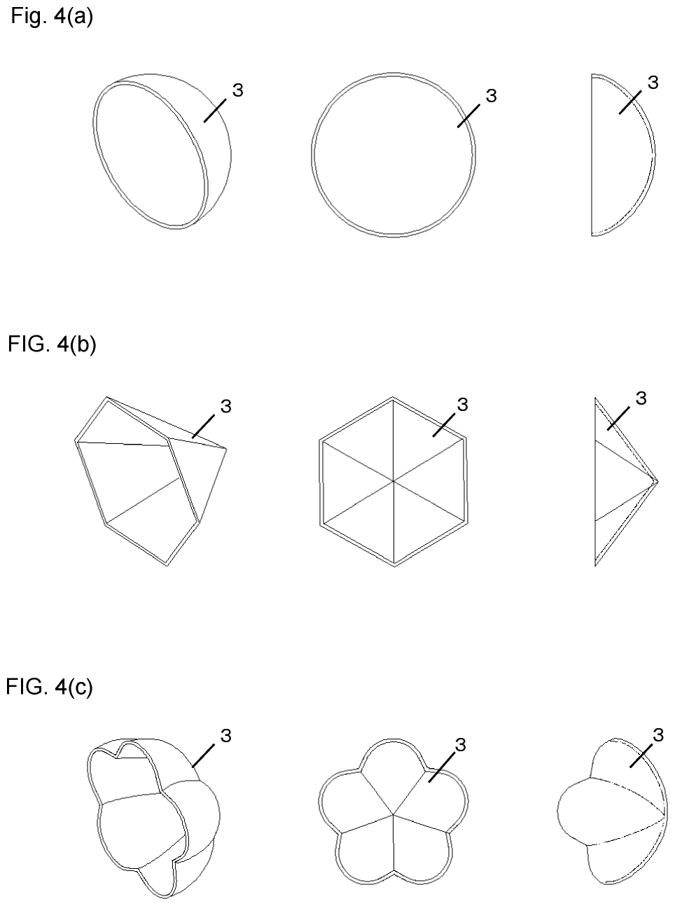

A second variation of this embodiment will be explained by referring to FIG. 4. In terms of the lure 1 according to Variation 2, the cup 3 does not have a bowl shape as shown in FIG. 4(a), but has a polygonal opening surface as shown in FIG. 4(b), a clover-shaped opening as shown in FIG. 4(c), and the like. In other words, the cup 3 only needs to have a recessed space 3a that can contain air. It is also possible to change the depth of the cup 3 and the volume of the recessed space 3a as appropriate depending on the situation of the fishing spot, the type of fish, and the like. Then, as described above, the cup 3 is removably fixed to the body 2 using a screw-in structure or the like, so as to select the most suitable shape and size of the cup 3 for each fishing situation. With this configuration, the same effects as in the above embodiment can be achieved.

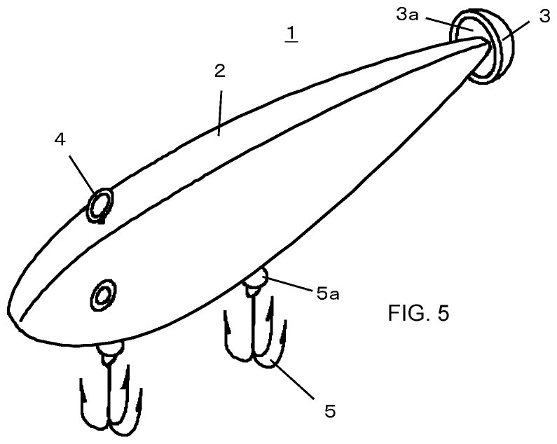

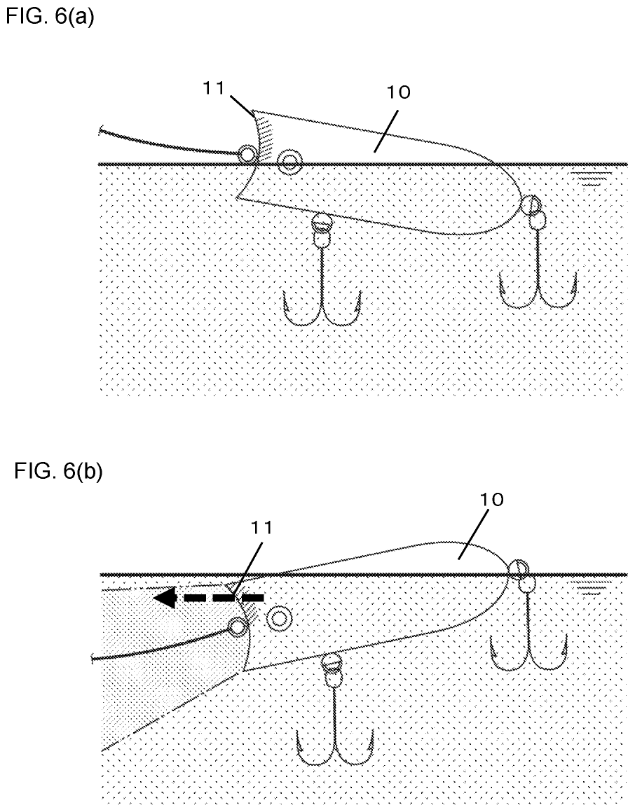

It is to be noted that the present disclosure is not limited to the above-described embodiments and modified examples, and various modifications are possible within the spirit and scope of the present disclosure. For example, as shown in FIG. 5, the cup 3 may be directly joined to the tail part of the body 2 without using any connection member 3b. The shape of the body 2 of the lure 1 is not limited to the shape of a small fish, and the position of the fishing line connection portion 4 is not limited to the head of the body 2. These may be formed at other parts.

The components labeled in the drawings include a lure 1, a body 2, a cup 3, a recessed space 3a, a cup connection member 3b, a through hole 3c, a fishing line connection part 4, a hook 5, and a hook connection part 5a.

1. A lure comprising:
a body having a shape resembling a small fish; and
a cup that is attached to the body, wherein the cup has a recessed space for containing air when the body enters water.

2. The lure according to claim 1, wherein the cup has a bowl shape, the cup is provided such that the head of the body is located at the front, and the cup is attached to the tail of the body so as to make the opening face of the bowl-shaped cup direct forward.

3. The lure according to claim 1, further comprising:
a cup connection member that connects the tail end of the body with the bottom of the cup, wherein a ratio between the height of the body and the diameter of the opening surface of the cup is in the range of 5:1 to 0.5:1.

4. The lure according to claim 1, wherein;
a specific weight distribution of the body is determined so as to make the head of the lure submerged into the water and make the tail completely float above the water surface during a floating posture with no action; and
the lure dives into the water while maintaining an acute angle posture against the water surface during an action.

5. The lure according to claim 1, wherein the cup further comprises a through hole formed on the bottom side of the cup, and the through hole can be penetrated through the body of the lure.

6. The lure according to claim 2, further comprising:
a cup connection member that connects the tail end of the body with the bottom of the cup, wherein a ratio between the height of the body and the diameter of the opening surface of the cup is in the range of 5:1 to 0.5:1.

7. The lure according to claim 2, wherein:
a specific weight distribution of the body is determined so as to make the head of the lure submerged into the water and make the tail completely float above the water surface during a floating posture with no action; and
the lure dives into the water while maintaining an acute angle posture against the water surface during an action.

8. The lure according to claim 3, wherein:
a specific weight distribution of the body is determined so as to make the head of the lure submerged into the water and make the tail completely float above the water surface during a floating posture with no action; and
the lure dives into the water while maintaining an acute angle posture against the water surface during an action.

9. The lure according to claim 2, wherein the cup further comprises a through hole formed on the bottom side of the cup, and the through hole can be penetrated through the body of the lure.

10. The lure according to claim 3,
wherein the cup further comprises a through hole formed on the bottom side of the cup, and
wherein the through hole can be penetrated through the body of the lure.

11. The lure according to claim 4, wherein the cup further comprises a through hole formed on the bottom side of the cup, and the through hole can be penetrated through the body of the lure.
